(19) United States
(12) Patent Application Publication
(10) Pub. No.: US 2022/0393279 A1
(43) Pub. Date: Dec. 8, 2022

(54) BATTERY PACK WITH REINFORCING ELEMENTS

(71) Applicant: Viessmann Climate Solutions SE, Allendorf (DE)

(72) Inventors: Clément LUDMANN, Metz (FR); Sébastien HOY, Spicheren (FR); Wolfgang RIEDL, Entrange (FR); Claude VALLET, Racrange (FR)

(21) Appl. No.: 17/779,154

(22) PCT Filed: Jan. 14, 2021
(86) PCT No.: PCT/EP2021/050693

§ 371 Date: May 24, 2022

(30) Foreign Application Priority Data
Jan. 31, 2020 (DE) 10 2020 201 204.0

(51) Int. Cl. H01M 50/213; H01M 50/227; H01M 50/251; H01M 10/052

(52) U.S. Cl. CPC H01M 50/213; H01M 50/227; H01M 50/251; H01M 10/052; H01M 2220/10

(57) ABSTRACT

A battery pack having a plurality of reinforcing elements disposed between cell holders and separating the cell connectors of the battery pack. Thereby, the battery pack according to the invention provides improved protection against short circuits during manufacture.

### TECHNICAL FIELD

The present invention relates to a battery which includes reinforcing elements as short-circuit protection during manufacture.

### TECHNICAL BACKGROUND

In times of renewable energies, energy storage systems play an increasingly important role, in particular for home applications. So far, this has led to the development of a large number of different battery types, such as zinc-manganese, zinc-air, mercury-zinc or lithium-ion batteries. Due to the comparatively lower reactivity and the resulting higher level of safety, lithium ferrophosphate batteries are of particular interest for home use.

In order to produce more powerful batteries, a plurality of battery cells are combined in a battery pack to form a battery, with the cells being connected to one another in series and parallel circuits in order to achieve a desired voltage and a desired battery capacity. For this purpose, the battery cells are mounted in cell holders and connected to one another via appropriate cell connectors.

For example, EP 2 891 195 B1 shows a battery pack including a plurality of battery cells. A cell carrier holds the plurality of batteries and a connecting part is connected to the plurality of batteries. A circuit substrate is used for mounting circuits for the plurality of batteries. The cell substrate is formed integrally with battery cell storing units that store the plurality of batteries, a base unit supporting the battery cell storing units, and shock relaxation ribs. Each shock relaxation rib is formed between an outer periphery of the base unit and an outer surface of each of the battery cell storing units and is configured in a shape capable of being deformed in a direction in which an impact occurs.

However, the manufacture of battery packs in particular still harbors risks. For example, metal objects may fall down during manufacture and cause short circuits in the cell connectors. This may happen when inserting the cell connectors themselves. Likewise, however, screws and nuts, which are used, for example, to fasten CSC, T-CSC circuit boards or a housing, may fall onto cell connectors already inserted and short them. It is also conceivable that personal items of employees involved in the manufacture of a battery pack are accidentally dropped.

It is therefore an object of the invention to provide a battery pack with improved short-circuit protection during manufacture.

### Solution to the Problem

The object is achieved by the features of independent claim 1 and independent claim 15. The dependent claims are directed to particular embodiments of the invention.

A battery pack according to the invention comprises a plurality of cell holders for receiving battery cells. The cell holders are arranged in N rows and M columns and are connected integrally to form a flat battery cell mount, with M and N each >3. In a preferred embodiment, M and N may each be >10.

The cell holders are configured to be open in the vertical direction so that both poles of the battery cells stored therein can be contacted. This means that the positive pole of a battery cell can be contacted on an upper side of the battery cell mount and the negative pole of the same battery cell can be contacted on the opposite lower side of the battery cell mount.

According to the invention, a plurality of battery cells are stored in the cell holders, with the same polarity within the N rows and opposite polarity within the M columns. In other words, the contactable polarity of the battery cells on each side of the battery cell mount alternates with each of the N rows.

According to the invention, the battery pack also includes a plurality of cell connectors which are arranged in a staggered manner over two of the N rows on both sides of the battery cell mount and connect the battery cells to one another. For example, the battery cells of the rows with N=1 and N=2, N=3 and N=4, N=5 and N=6 etc. may be interconnected via cell connectors on the upper side of the battery cell mount, while, correspondingly, the battery cells of the rows with N=2 and N=3, N=4 and N=5, N=6 and N=7, etc. may be interconnected via cell connectors on the opposite lower side.

According to the invention, the battery pack also comprises a plurality of reinforcing elements arranged between the N rows at an interval of two rows each such that they separate the cell connectors arranged over the respective two of the N rows. The reinforcing elements are formed higher than the cell holders in a longitudinal direction.

By separating the cell connectors by means of the reinforcing elements, greater protection against short circuits during the manufacture of the battery pack can advantageously be achieved since the reinforcing elements serve as a barrier against falling metal objects. The metal objects come to rest on the reinforcing elements and can therefore no longer short the battery cells via the cell connectors.

In a preferred embodiment, the reinforcing elements may be integrally connected to the cell holders. In other words, in this embodiment, the cell holders may form a battery cell mount integral with the reinforcing elements. In addition to the barrier effect, this may advantageously also improve the stability of the battery pack against horizontal deformation, which in turn improves the stackability of the battery pack.

In another preferred embodiment, the reinforcing elements may be configured as reinforcing ribs with at least one indentation. A reinforcing rib may be configured, for example, in the form of a partition wall having the at least one indentation in an area between adjacent cell holders. The technical effect of the at least one indentation can be compared with the effect of an expansion joint which can compensate for a deformation of the battery cell mount, for example as a reaction to heating/cooling. Particularly preferably, the reinforcing ribs may have two indentations.

In a preferred embodiment, the cell holders and the reinforcing elements may be made of plastic. Particularly preferably, the cell holder and the reinforcing elements may be made of the same plastic.

In a particularly preferred embodiment, the plastic may be acrylic butadiene styrene (ABS).

In a very particularly preferred embodiment, the cell holder and the reinforcing elements may be manufactured using injection die casting methods or vacuum casting methods, for example as a one-piece battery cell mount. In this case, the at least one indentation mentioned above may positively influence the rheology of the component during the manufacturing process, i.e. prevent deformation of the battery cell mount in response to temperature differences, for example in a cooling process.

In a further preferred embodiment, pin-shaped spacers may be arranged in a row alternating with the reinforcing elements on the cell holders. In a particularly preferred embodiment, the reinforcing elements may extend in the longitudinal direction below the spacers. In other words, the spacers may be formed higher than the reinforcing elements in the longitudinal direction. Preferably, the reinforcing elements may extend in a range of 1.0 mm to 0.2 mm below the spacers. Very particularly preferably, however, the reinforcing elements may extend up to 0.5 mm below the spacers. In other words, the reinforcing elements may extend in a range up to above the cell holders and below the spacers in the longitudinal direction.

In addition to the reinforcing elements, the pin-shaped spacers can also improve stackability of the battery pack. In addition, such spacers may be used to define the distance from a housing in which the battery pack can be installed. In this way, leakage current can be avoided, for example. This is particularly important for meeting specific protection classes.

In general, battery cells may be connected to one another in series and parallel circuits to achieve a desired voltage and capacity. In a preferred embodiment, the battery cells may be connected M in parallel and N in series. The circuit may particularly preferably be 15 in series and 16 in parallel.

The type of battery cells is not restricted according to the invention. In a preferred embodiment, however, the battery cells may be plastic-coated round cells.

The type of battery cells is also not restricted according to the invention. In a particularly preferred embodiment, however, the battery cells may be lithium-ferrophosphate cells. In this way, the safety of the battery pack can advantageously be increased since lithium-ferrophosphate cells are comparatively less reactive.

According to the invention, the shape of the cell holder is not restricted. In another preferred embodiment, however, the cell holders may have a cylindrical shape. The cylindrical shape is particularly advantageous for storing the above-mentioned plastic-coated round cells.

In a further preferred embodiment, the battery pack may have at least 4 passages for connecting elements. The term connecting elements is to be interpreted broadly here and may include elements of both plug connection and screw connection. However, screw connections, for example screw and nut, are preferred. The battery pack may be connected to a surrounding housing, for example, by means of the passages.

The battery pack according to the invention is preferably used in a battery module for home applications. Such a home application includes, in particular, modular storage systems which, for example, make one-family or multi-family houses independent of the public power grid.

### BRIEF DESCRIPTION OF THE DRAWINGS

FIGS. 1 and 2a, 2b schematically show a battery pack according to an embodiment.

FIG. 3 schematically shows a reinforcing element according to one embodiment.

FIG. 4 schematically shows a portion of a battery pack with spacers and a reinforcing element according to one embodiment.

FIG. 5 schematically shows a battery pack with passages for connecting elements according to an embodiment.

### DETAILED DESCRIPTION OF THE INVENTION AND PREFERRED EXEMPLARY EMBODIMENTS

In the following, examples or exemplary embodiments of the present invention are described in detail with reference to the attached figures. Identical or similar elements in the figures may be denoted by the same reference symbols, but sometimes also by different reference symbols.

It should be emphasized that the present invention is in no way limited or restricted to the exemplary embodiments described below and their implementation features, but also includes modifications of the exemplary embodiments, in particular those that are included within the protective scope of the claims via modification of the features of the examples described or by combining one or more features of the described examples.

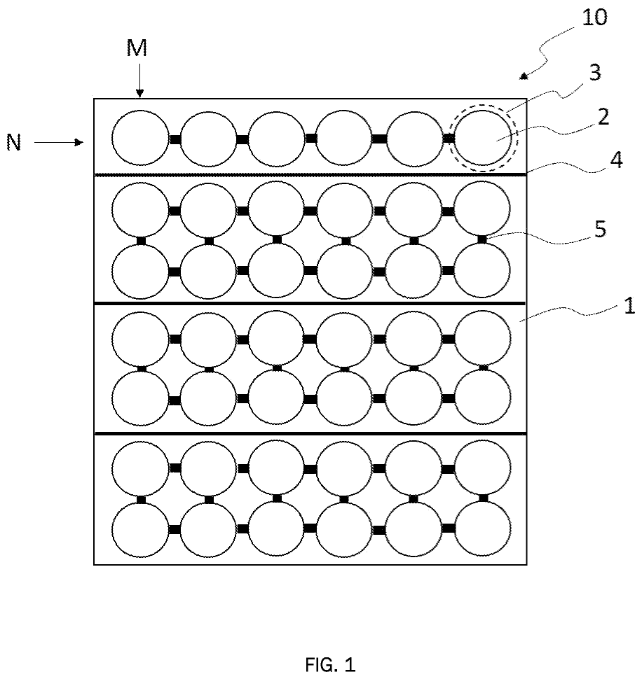

FIG. 1 schematically shows a battery pack according to an embodiment. The battery pack 10 includes a plurality of battery cells 2 each surrounded by respective cell holders 3 for storing the battery cells 2 therein. The cell holders 3 are arranged in N rows and M columns and are integrally connected to one another so that a flat battery cell mount 1 is formed, where M and N each >3. The number of N rows and M columns is not restricted according to the invention and may be selected according to the application requirements the battery pack. However, in a preferred embodiment, M and N may each be >10. However, the battery pack 10 may preferably also have N=15 rows and M=16 columns of cell holders 3.

The cell holders 3 are open in the vertical direction, i.e. toward the upper and lower sides of the battery cell mount 1. The battery cells 2 may be stored in these cell holders 3, for example via corresponding fixing elements (not shown). Because the cell holder 3 is open at the top and bottom, the battery cells 2 stored therein can be contacted on both sides of the battery cell mount 1, i.e. both the positive pole and the negative pole of a battery cell 2 can be contacted.

The shape of the cell holder 3 is not restricted according to the invention and may be based on the shape of the battery cells 2 to be stored therein. In a preferred embodiment, however, the cell holders 3 may have a cylindrical shape.

The type and kind of battery cells 2 are also not restricted according to the invention. In a preferred embodiment, the battery cells 2 may be plastic-coated round cells 2.

In a particularly preferred embodiment, the battery cells 2 may also be lithium-ferrophosphate cells. Lithium-ferrophosphate cells have the advantage that they are less reactive than other battery cells and are therefore safer.

According to the invention, the battery pack 10 further includes a plurality of cell connectors 5. Cell connectors are generally used to combine battery cells in a battery pack into one battery, with the battery cells being connected in series and in parallel. According to the invention, cell connectors 5 are arranged on both sides of the battery cell mount 1 in a staggered manner over two of the N rows of cell holders 3 and interconnect the battery cells 2 mounted therein. The type of interconnection is not restricted according to the invention and may be selected according to the application requirements for the battery pack. In a preferred embodiment, however, the battery cells 2 may be connected M in parallel and N in series. Particularly preferably, the battery cells 16 may be connected 16 in parallel (16p) and 15 in series (15s).

Moreover, the battery pack 10 according to the invention includes a plurality of reinforcing elements 4. The reinforcing elements 4 are arranged between the N rows of cell holders 3 at in interval of two rows each. In a longitudinal direction, the reinforcing elements 4 are formed higher than the cell holders 3 in such a way that they separate the cell connectors 5 arranged over the respective two of the N rows. In other words, reinforcing elements 4 are arranged alternately at an interval of two rows with respect to the rows connected via cell connectors.

The reinforcing elements offer the advantage that metal objects that may fall down during manufacture of the battery pack no longer come to lie across several rows of cells, thereby possibly causing a short circuit. The reinforcing elements thus serve as a kind of barrier. In addition, the reinforcing elements may also reinforce the battery pack, in particular the flat battery cell mount, against deformation.

In a preferred embodiment, the cell holders 3 and the reinforcing elements 4 may be made of plastic. Particularly preferably, the cell holder 3 and the reinforcing elements 4 may be made of the same plastic. In a particularly preferred embodiment, the plastic may be acrylic butadiene styrene (ABS). In a very particularly preferred embodiment, the cell holders 3 and the reinforcing elements 4 may be manufactured by means of injection die casting or vacuum casting methods.

In another preferred embodiment, the reinforcing elements 4 may be integrally connected to the cell holders 3. In this way, the stability of the battery cell mount can be increased even further and a possible slip of the reinforcing elements can be avoided.

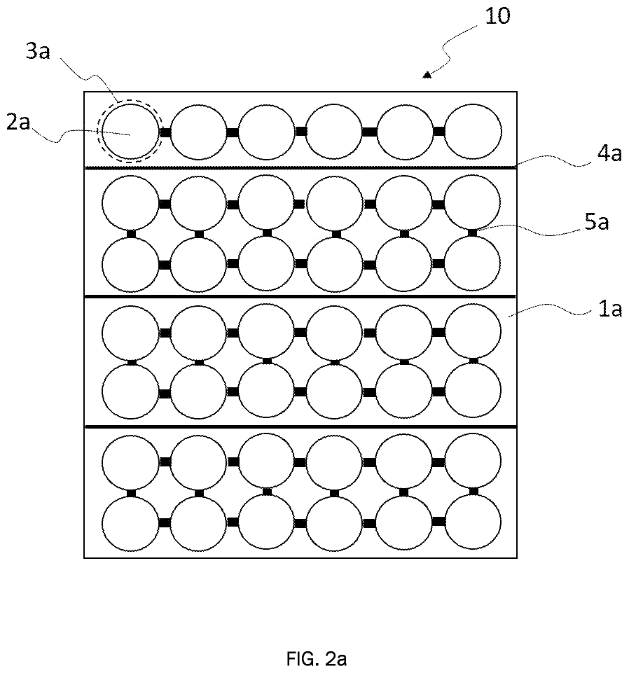

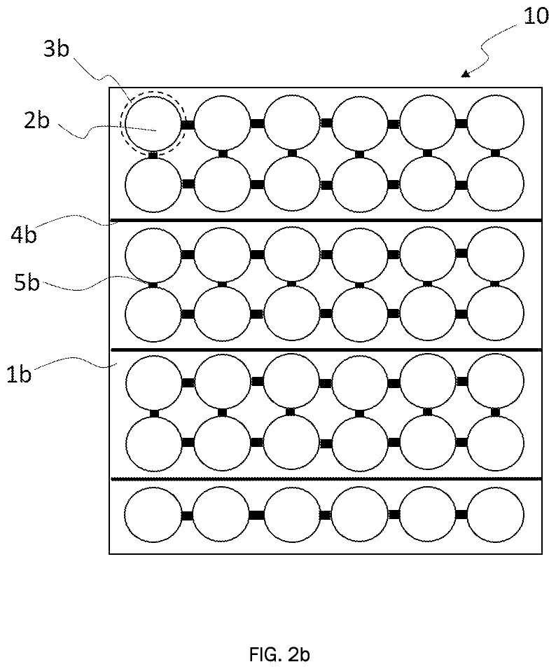

As a supplement to FIG. 1, FIGS. 2a and 2b schematically show both sides of a battery pack according to an embodiment. In FIG. 2a, 1a corresponds to an upper side of the battery cell mount, and in FIG. 2b, 1b corresponds to a lower side of the battery cell mount. Corresponding to the side identification, the further reference symbols are identified analogously to FIG. 1 with the indices a and b in FIGS. 2a and 2b. As is apparent in FIGS. 2a and 2b, cell connectors 5a, 5b are arranged offset on both sides 1a, 1b of the battery cell mount over two of the N rows and connect the battery cells 2a, 2b stored in the cell holders 3a, 3b to one another. On each of the two sides 1a, 1b, reinforcing elements 4a, 4b are arranged at an interval of two rows between the N rows, respectively. The reinforcing elements 4a, 4b are each formed higher in a longitudinal direction than the cell holders 3a, 3b such that they separate the cell connectors 5a, 5b arranged above the two of the N rows.

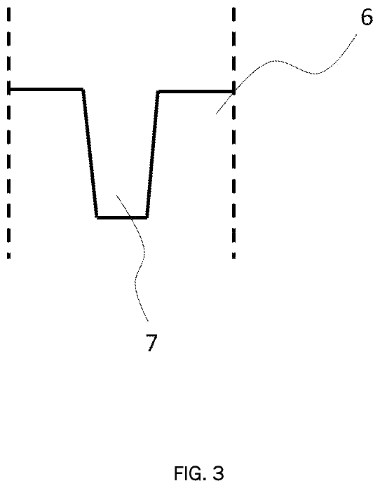

FIG. 3 schematically shows a reinforcing element according to an embodiment. The reinforcing element is shown in detail here and is configured as a reinforcing rib 6 in this embodiment. As indicated by the dashed lines in FIG. 3, a reinforcing rib 6 may be arranged between two adjacent cell holders. The reinforcing ribs 6 may be arranged between the adjacent cell holders in the row direction and may extend over the entire length of a row. The reinforcing ribs 6 may be higher than the cell holders in a longitudinal direction.

In a preferred embodiment, the reinforcing elements may be configured as reinforcing ribs with at least one indentation. The reinforcing rib 6 shown in the embodiment in FIG. 3 has an indentation 7. The indentation 7 may in particular be wedge-shaped. The at least one indentation may advantageously function as a type of expansion joint which can prevent deformation of the battery cell mount, for example as a function the temperature. When the cell holder and the reinforcing ribs are formed integrally from plastic, for example, using injection die or vacuum casting, the at least one indentation may prevent deformation of the resulting battery cell mount during the cooling process.

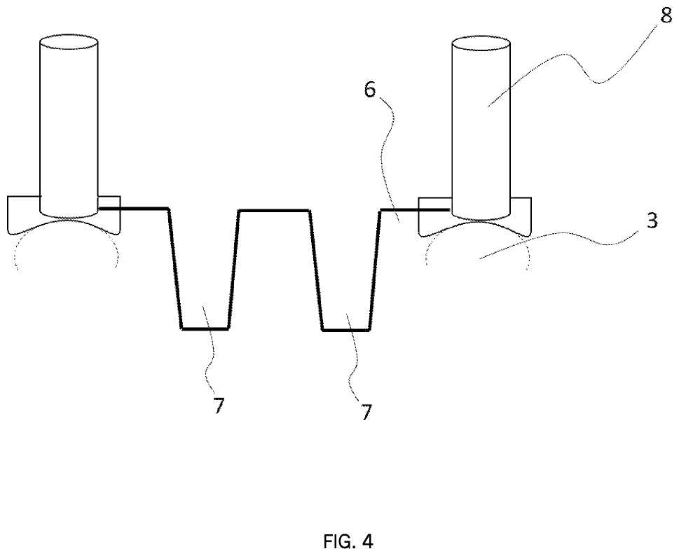

FIG. 4 schematically shows a portion of a battery pack according to an embodiment with spacers and a reinforcing element. In the embodiment in FIG. 4, the reinforcing element is configured as a reinforcing rib 6 with two indentations 7. In this case, too, the two indentations 7 may in particular be wedge-shaped. In contrast to FIG. 3, the cell holders 3 shown in the embodiment in FIG. 4 each include a pin-shaped spacer 8. The reinforcing ribs 6 may extend below the spacers 8 in the longitudinal direction, preferably in a range from 1.0 mm to 0.2 mm, but particularly preferably up to 0.5 mm below the spacers 8. The pin-shaped spacers 8 may be arranged alternately with the reinforcing ribs 6 in the row direction on the cell holders 3. When the battery pack is installed in a housing, for example, a distance from the housing wall may advantageously be defined by the spacers. In this way, the occurrence of leakage current can be avoided. In addition, the spacers can improve the stackability of the battery packs.

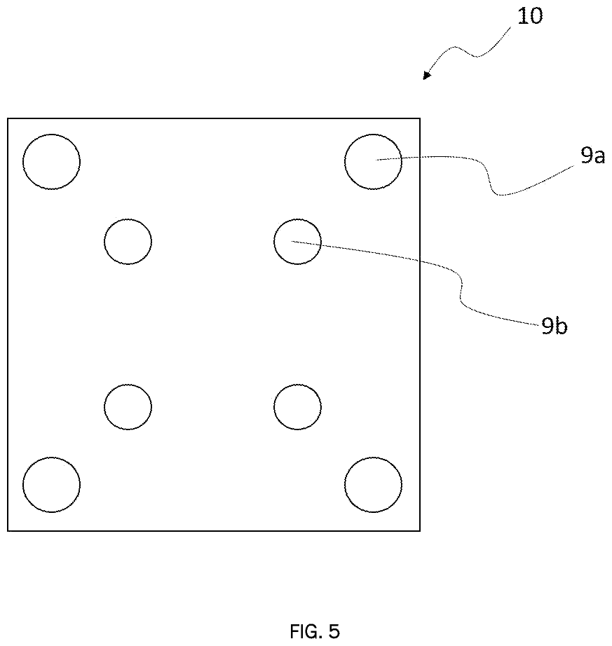

FIG. 5 schematically shows an embodiment of a battery pack with passages for connecting elements. In a preferred embodiment, the battery pack 10 may have at least four passages 9a, 9b for connecting elements. The four passages may be arranged either in the center 9b on the battery pack 10 or in the area of the corners 9a of the battery pack 10. Advantageously, the battery pack 10 may also have four passages both in the center 9b and in the area of the corners 9a. According to the invention, the passages 9a, 9b are not restricted with respect to the connecting elements. The connecting elements may include plug connections or screw connections, such as screws and nuts, and the passages 9a, 9b may be configured accordingly. However, the passages 9a, 9b may advantageously be configured for screw connections. The battery pack 10 may be connected, for example, to a surrounding housing via the connecting elements routed through the passages 9a, 9b.

The battery pack of the present invention may be used in a battery module for home applications. In particular, home applications may be modular storage systems which, for example, make one-family or multi-family houses independent of the public power grid and are fed via alternative energy sources such as solar energy.

### LIST OF REFERENCE SYMBOLS

10 battery pack
1 battery cell mount
1a upper side of the battery cell mount
1b lower side of the battery cell mount
2, 2a, 2b battery cell
3, 3a, 3b cell holder
4, 4a, 4b reinforcing element
5, 5a, 5b cell connectors
6 reinforcing rib
7 indentation
8 spacer
9a, 9b passage

1. A battery pack (10), comprising:
a plurality of cell holders (3, 3a, 3b) for receiving battery cells (2, 2a, 2b) which are arranged in N rows and M columns and are integrally connected to one another so that a flat battery cell holder (1) is formed, with M and N each >3, wherein said cell holders (3, 3a, 3b) are open in the vertical direction such that both poles of a battery cell (2, 2a, 2b) stored therein can be contacted,
a plurality of battery cells (2, 2a, 2b) stored in said cell holders (3, 3a, 3b) with equal polarity within the N rows and opposite polarity within the M columns, respectively, a plurality of cell connectors (5, 5a, 5b) which are arranged on both sides (1a, 1 b) of said battery cell mount (1) in a staggered manner over two of the N rows, respectively, and interconnect said battery cells (2, 2a, 2b) with one another, and
a plurality of reinforcing members (4, 4a, 4b) which are arranged between the N rows at an interval of two rows and are formed higher in a longitudinal direction than said cell holders (3, 3a, 3b) such that they separate two cell connectors (5, 5a, 5b) arranged over the respective two of the N rows.

2. The battery pack (10) according to claim 1, wherein M and N each are >10.

3. The battery pack (10) according to claim 1, wherein said reinforcing elements (4, 4a, 4b) are integrally connected to said cell holders (3, 3a, 3b).

4. The battery pack (10) according to claim 1, wherein said reinforcing elements (4, 4a, 4b) are configured as reinforcing ribs (6) with at least one indentation (7).

5. The battery pack (10) according to claim 1, wherein said cell holders (3, 3a, 3b) and said reinforcing elements (4, 4a, 4b) are made of plastic.

6. The battery pack (10) according to claim 5, wherein said plastic is acrylic butadiene styrene (ABS).

7. The battery pack (10) according to claim 5, wherein said cell holders (3, 3a, 3b) and said reinforcing elements (4, 4a, 4b) are manufactured by means of injection die casting or vacuum casting.

8. The battery pack (10) according to claim 1, wherein pin-shaped spacers (8) are arranged alternately with said reinforcing elements (4, 4a, 4b) in the row direction on said cell holders (3, 3a, 3b).

9. The battery pack (10) according to claim 8, wherein said reinforcing elements (4, 4a, 4b) extend up to below said spacers (8) in the longitudinal direction.

10. The battery pack (10) according to claim 1, wherein said battery cells (2, 2a, 2b) are connected M in parallel and N in series.

11. The battery pack (10) according to claim 1, wherein said battery cells (2, 2a, 2b) are plastic-coated round cells.

12. The battery pack (10) according to claim 1, wherein said battery cells (2, 2a, 2b) are lithium-ferrophosphate cells.

13. The battery pack (10) according to claim 1, wherein said cell holders (3, 3a, 3b) are cylindrical in shape.

14. The battery pack (10) according to claim 1, wherein said battery pack (10) has at least four passages (9a, 9b) for connecting elements.

15. Use of the battery pack (10) according to claim 1 in a battery module for home applications.
